(19) United States
(12) Patent Application Publication
(10) Pub. No.: US 2012/0280114 A1
(43) Pub. Date: Nov. 8, 2012

(54) MULTIFUNCTIONAL RADIOMETER, HOSPITAL EQUIPMENT, MULTIUSE MEASUREMENT TOOL, SYSTEM AND METHOD FOR MEASURING IRRADIANCE IN PHOTOTHERAPY

(76) Inventors: Djalma Luiz Rodrigues, Sao Paulo (BR); Orlando Rossi Filho, Poa (BR)

(21) Appl. No.: 13/512,818

(22) PCT Filed: Aug. 31, 2010
(86) PCT No.: PCT/BR10/00280

§ 371 Date: Jul. 16, 2012

(30) Foreign Application Priority Data
Nov. 30, 2009 (BR) PI0904575-9

(51) Int. Cl. G01J 1/44

(52) U.S. Cl. 250/214.1

(57) ABSTRACT

The present invention refers to a multifunctional radiometer having at least onen optical sensor (7), capable of allowing conversion of the incident light into an electrical sign, comprising at least: one selection key capable of allowing the selects of a type of luminous source (2) whose irradiance is wished to be measured; and one control unit (4) operatively connected to the optical sensor (7) and to the selection key, the control unit (4) being configured to calculate at least one irradiance value from a data originated from the optical sensor (7) and from a command originated from the selection key. The present invention also refers to a method for measuring irradiance in phototherapy, comprising the steps of i) selecting a type of luminous source (2) whose irradiance is wished to be measured (unprecedented fact in this type of tool, once it is necessary distinct calibrations for different types of spectral light source); ii) capturing light emitted by the luminous source (2); iii) converting the light captured in step ii into an electrical sign; and iv) calculating at least one irradiance value from the type of luminous source selected in step i and from the electrical sign obtained in step iii. The present invention further refers to a system, to a hospital equipment and to a multiuse measurement tool (10) capable of implementing the method abovementioned.

The present invention refers to a radiometer capable of accurately measuring the irradiance of a plurality of types of luminous sources.

The present invention also refers to a multiuse measurement tool, for application in the medical-hospital field, capable of accurately measuring multiple physical quantities, among them, the irradiance of a plurality of types of luminous sources.

The present invention further refers to a system and a method, for application in phototherapy treatments, capable of allowing the measurement of irradiance of a plurality of types of luminous sources, without the need of using multiple radiometers of photometers.

### BACKGROUND OF THE INVENTION

Hyperbilirubinemia is an anomaly, usually observed in newborns (neonates), related to a raise in the levels of serum bilirubin in their organisms, which may cause the emergence of a yellowish color in the sclera, in the mucosae (mucous membranes), and/or in the skin, called jaundice. Neonatal jaundice affects approximately 60% of the newborns, of whom 10 to 15% require treatment.

Treatment of hyperbilirubinemia started in England in the late 1950s when it was noted that the sunlight emitted over the skin a jaundiced neonate sensibly reduced the serum levels of bilirubin. Upon such evidence, the first phototherapy devices were developed, with fluorescent lamps that work within the spectrum of visible light in the blue range (wavelength of light between 400 and 550 nm), which have been used until today. These photo-therapy devices are capable of transforming the bilirubin molecules into non-toxic isomers, which are soluble in water, to be eliminated from the organism through the kidneys.

With the advancement of technology over time, other types of luminous sources have been developed, which are more efficient, for instance, fluorescent lamps capable of emitting blue light, halogen lamps, lamps of leds, and currently, the Super Leds, which are used, for instance, in the phototherapy equipment Bilitron® 3006 manufactured by company Fanem® Ltda.

It is worth noting that the efficacy of phototherapy depends on the luminous intensity (output of visible irradiance emitted by a luminous source available in a certain direction), on the wavelength (color) of light, as well as on the skin's surface area exposed to light. Therefore, to enable the supervision and control of the amount (dose) of light to be applied to a newborn, it is necessary to capture the luminous power emitted by the luminous source. Such capture can be performed by means of a radiometer, which is a device capable of measuring irradiance (amount of light or power emitted per area unit in a certain spectrum), that is, capable of providing irradiance values in a certain range of the light spectrum of a known luminous source. In phototherapy applications, the radiometer shall be configured to measure irradiance in the visible blue spectrum, usually used in phototherapy for the treatment of hyperbilirubinemia, once it is more effective on transforming the bilirubin molecules into isomers.

However, the luminous irradiance meters or radiometers/photometers have not evolved at the same speed compared to the evolution of lamps (light source). The radiometers currently used for treating hyperbilirubinemia consider only one type of lamp as a standard type of luminous source, usually fluorescent lamps, which may result in inaccurate measurements if one wants to measure the irradiance of another type of light source.

For instance, in tests and trials carried out at the Optics Laboratory of the Institute for Technological Research from Sao Paulo (IPT), it was possible to verify that each type of lamp has a specific intensity of light emission for each range of the luminous spectrum.

Therefore, the radiometers currently known are not capable of accurately providing irradiance values accurately for the different types of luminous sources suitable for the treatment of hyperbilirubinemia.

The first phototherapy devices used fluorescent lamps, which produced a phototherapy effect more efficient than light irradiation by means of common lamps, because they emit a high rate of luminous radiation in a “cold” manner, that is, a spectrum of whiter light. However, the irradiation level of fluorescent lamps was very low, making it necessary to use several lamps simultaneously, requiring the use of a large sized device so that the irradiating power was sufficient for the desired healing effect.

To solve this serious drawback, it was researched and studied the application of high-irradiance blue fluorescent lamps, developed and manufactured in order to be used in phototherapy devices. However, these lamps, in spite of emitting light with properties more suitable for performing phototherapy, still had the insuperable disadvantage of being quite lengthy.

With the advancement of technology, halogen lamps were introduced at the market (lamps such as filament surrounded by an atmosphere of halogen gas), whose performance is quite superior to that of fluorescent lamps in the treatment of hyperbilirubinemia, with their size much reduced. However, this type of lamp generates much heat, which requires cooling by using fans and filtering by using infrared and ultraviolet filters, in order to reduce the undesired effects caused to the neonate's body. Moreover, this type of lamp has a relatively short life cycle (about 2000 hours) and must be replaced at intervals shorter than desirable.

To eliminate the excessive heat caused by phototherapy luminous irradiation, the technology evolved and started employing lamps in solid state or common blue LEDs (light emission diodes), which helped at expressly reducing the phototherapy light sources for the treatment of bilirubin. However, these common LEDs do not have good irradiation if they are considered individually, so it is necessary to use many LEDs together so that the treatment effect is satisfactory. In addition, it is necessary more proximity to the patient's body, making the use of this device limited for some applications, where it is necessary to position the light source over the patient.

The so-called super LEDs are different from conventional LEDs of gallium nitride (GaN), once they are comprised by indium nitride and gallium nitride (InGaN), and emit high light power in a small visible range of the electromagnetic radiation spectrum (blue), with the absence of emission of infrared radiation. This super LED preferably consists of several LEDs in a same pastille (high scale integration), forming four or more blocks of 4 leds each.

The pastille of a “super LED” is deposited through a dense film onto an aluminum plate shaped as a star or not to enable a better dissipation of output. The super LED body has terminals arranged on the film surface over the aluminum. Conventional LEDs, on the other side, due to their low power density, do not need an aluminum body for output dissipation. Their construction is made with one pastille and just one LED is covered by a transparent acrylic body which gives a cylindrical shape, and its terminals leave through the lower part of the acrylic body.

The wavelength of the light emitted by the super LED is 450 nm, making it unnecessary the installation of filters for controlling the emitted light (notably infrared and ultraviolet rays, which are invisible).

Super LEDs are components which are already known and already used in dental equipments for resin polymerization; however, they had never been used in phototherapy for treating hyperbilirubinemia and in other therapies.

### Purposes of the Invention

One first purpose the present invention is to supply a measurement device capable of capturing luminous power to accurately provide irradiance values for a plurality of types of luminous sources.

Moreover, a second purpose of this invention is to supply a multiuse measurement device or hospital equipment (the latter combined with other functionalities), to be employed in the hospital and medical field, capable of accurately measuring multiple physical quantities, including irradiance in phototherapy of a plurality of types of luminous sources.

Additionally, a third purpose of this invention is to supply a system that allows accurately measuring the irradiance of a plurality of types of luminous sources, without the need of using multiple measurement devices designed (each one) to have optimal performance with only one type of sensor of luminous source and, thus, allow more easiness, simplicity and flexibility of use.

Finally, a fourth purpose of this invention is to supply a method that allows capturing the power emitted by a luminous source, in order to enable the accurate measurement of the irradiance for a plurality of types of luminous sources.

### BRIEF DESCRIPTION OF THE INVENTION

The first purpose of this invention is achieved by means of a radiometer having at least one optical sensor capable of allowing conversion of an incident light into an electrical sign. In addition, the radiometer also comprises at least one selection key capable of allowing selection of a type of luminous source whose irradiance is wished to be measured. Additionally, the radiometer further comprises at least one control unit, operatively connected to the optical sensor and to the selection key, configured to calculate at least one irradiance value from a data originated from the optical sensor and from a command originated from the selection key.

The second purpose of the present invention is achieved by means of a multiuse measurement tool or hospital equipment having at least one first connector configured to allow the coupling of a thermo-hygrometer. Moreover, the multiuse measurement tool also has at least one second connector configured to allow the coupling of an optical sensor capable of allowing the conversion of the incident light into an electrical sign. Additionally, the multiuse measurement tool comprises at least one selection key capable of allowing the selection of a type of luminous source whose irradiance is wished to be measured. Moreover, the multiuse measurement tool comprises at least one control unit, operatively connected to the optical sensor and to the selection key, configured to calculate at least one irradiance value from a data originating from the optical sensor and from a command originated from the selection key.

The third purpose of this invention is achieved through a system for measuring irradiance in phototherapy. Such system has at least one light detection means capable of capturing light emitted by a luminous source. Moreover, the system also comprises at least one means for selecting the type of luminous source whose irradiance is wished to be measured. Additionally, the system further comprises at least one control unit, operatively associated with the light detection means and with the means for selecting the type of luminous source, configured to calculate at least one irradiance value from data originated from the light detection means and from the means for selecting the type of luminous source.

The fourth purpose of this invention is achieved by means of a method for measuring irradiance in phototherapy, which comprises the following steps i) selecting a type of luminous source whose irradiance is wished to be measured; ii) capturing the light emitted by the luminous source; iii) converting the light captured in step ii into an electrical sign; and iv) calculating at least one irradiance value from the type of luminous source selected in step i and from the electrical sign obtained in step iii.

### BRIEF DESCRIPTION OF THE DRAWINGS

The present invention will be described next in further details, with reference to the attached drawings, in which:

FIG. 1—illustrates a system for measuring irradiance in phototherapy, an object of the present invention; and

FIG. 2—illustrates a multiuse measurement tool, also an object of the present invention.

### DETAILED DESCRIPTION OF THE FIGURES AND INVENTION

### System for Measuring Irradiance in Phototherapy

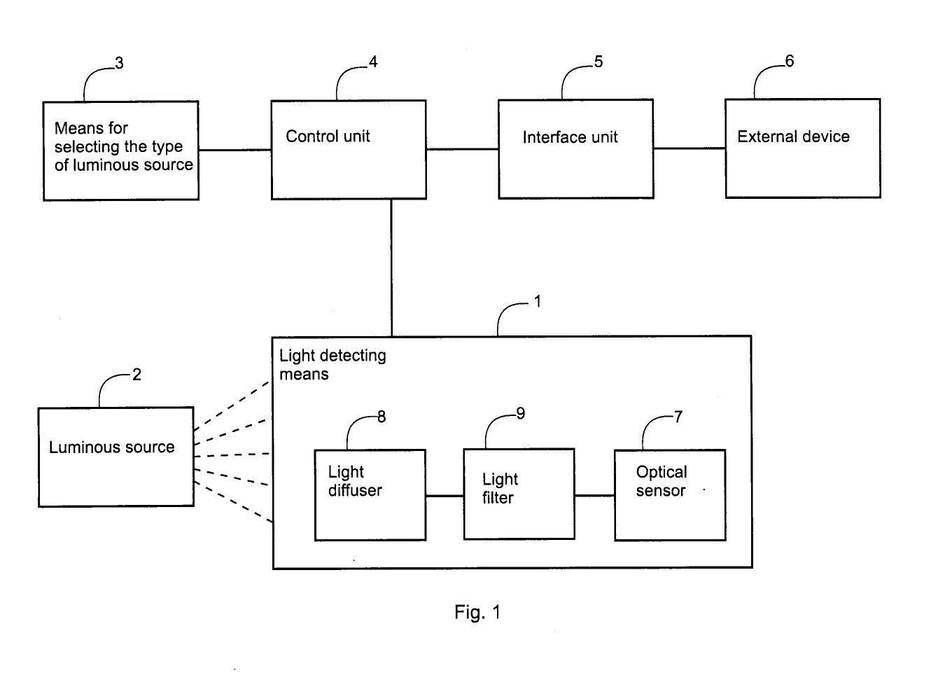

FIG. 1 illustrates a block diagram of a system for measuring irradiance in phototherapy according to a preferable embodiment of the present invention. The system covered by the present invention comprises a light generating equipment (luminous source 2) and an equipment that measures and processes the irradiance values (radiometer or photometer, which will be further described hereunder).

It is worth noting that the description of the radiometer itself explains further ahead the components that specifically belong to it. At first, the system is treated as a whole, and the radiometer is not specifically described/represented.

As previously described, the treatment of hyperbilirubinemia using phototherapy consists of the application of visible light in the blue range over the patient through a luminous source 2, comprised by phototherapy devices, such as Bilitron® 3006-BTP, Bilispot® 006-BP or Octofoto® 006-OFL, manufactured by company Fanem® Ltda., or also another equipment conceived for such purpose.

The system has at least one light detection means 1, capable of capturing light emitted by the luminous source 2, comprised by an optical sensor 7 capable of allowing the conversion of the incident light intensity into an electrical sign, for instance, current or electric voltage. In other words, the optical sensor 7 provides an electrical sign according to the variation of incident light (light falling upon it). The optical sensor 7 is operatively associated with a conditioning electronic circuit, so that the physical quantity can be converted into an analog electrical sign so that, afterwards, it can be amplified and/or converted into a digital electrical sign. Naturally, such sensor can be provided as a transducer. As a possible example of optical sensor 7, it is possible to mention a silicon photodiode which provides a linear electrical current according to the variation of light that falls upon it.

Moreover, the light detection means 1 has a light diffuser 8, operatively associated with the optical sensor 7, capable of correcting the bending effect of the light rays emitted by the luminous source 2 over the optical sensor 7.

Additionally, the light detection means 1 comprises a light filter 9, arranged between the light diffuser 8 and the optical sensor 7, tuned in to allow capturing luminous waves which have wavelengths ranging from 400 to 550 nm. This range of values for wavelengths defines a spectrum of the blue light, suitable for treating hyperbilirubinemia; that is, within this spectrum the light is optimally absorbed by bilirubin. The light filter 9 may be an optical filter by absorption or interference or also a combination thereof.

This way, as a general rule, the light detection means 1 is configured to capture luminous waves that have wavelengths ranging from 400 to 550 nm.

The system also comprises a means for selecting 3 the type of luminous source 2 capable of allowing the selection among a fluorescent lamp, a halogen lamp, a conventional LED (for instance, gallium nitride), a Super-LED (for instance, a LED of indium and gallium nitride) or also any other means for emitting light whose irradiance is wished to be measured, suitable for treating hyperbilirubinemia, once the system configuration is adaptable and flexible to any kind of lamp. The means for selecting 3 the luminous source 2 consists of a key, an electronic key or any other suitable means (mechanical, electrical or electromechanical) which allows selecting variables such as a touchscreen.

The system further comprises a control unit 4, operatively associated with the light detection means 1 and with the means for selecting 3 the type of luminous source 2, configured to calculate at least one irradiance value from data originated from the light detection means 1 and from the means for selecting 3 the type of luminous source 2.

More specifically, the control unit 4 is configured to apply, at least, one correction factor to the irradiance value initially calculated; according to the type of luminous source 2 selected through the selection means 3.

Preferably, the control unit 4 consists of a programmable microprocessor or a microcontroller. Alternatively, the control unit 4 can be replaced with an equivalent electronic circuit comprised by analog and/or digital electronic components, without prejudice to the invention.

Therefore, correction is preferably made by means of a computer algorithm to be run by the microprocessor or microcontroller.

Preferably, correction can be made by multiplying at least one correction factor by the irradiance value initially calculated, according to the type of luminous source selected through the selection means 3. After many studies and analyses, the applicant calculated a correction factor which lies, for instance, in the relationship between an irradiance experimentally obtained and a reference irradiance for each type of luminous source 2, wherein the reference irradiance consists of a theoretical value (for instance, obtained from a known standard irradiance curve by wavelength) or a specific value for a pre-established or predetermined type of luminous source (for instance, fluorescent lamp). In this regard, just as researched and developed by the applicant, one must obtain at least one correction factor for each type of luminous source 2, except the reference luminous source, wherein, if necessary, it is possible to implement multiple correction factors for each type of luminous source 2, in order to obtain a more accurate measure. Naturally, it is possible to use other quantities which are proportional to irradiance or also other methods of calculating the correction factor. Correction factors can be stored in the internal memory of the microcontroller/microprocessor or also be stored in an external memory.

Optionally, correction can be made through the use of specific tables for each type of luminous source 2, wherein each table is experimentally obtained by measuring the luminous intensity or some corresponding electrical quantity, such as voltage or electric current due to the variation of the wavelength (spectrum) of the light emitted by the respective luminous source 2. These tables can be stored in the internal memory of the microcontroller/microprocessor or also be stored in an external memory.

Thus, the equipment covered by the present invention, regardless of the correction factor to be used, enables an optimal performance for a plurality of types of luminous sources 2 and, therefore, more easiness, simplicity and flexibility of use are offered.

Furthermore, as a great innovative characteristic, the control unit 4 of the system is also configured to allow the adaptation/calibration of the optical sensor 7 to any types of luminous source 2, even to those not initially provided in a project and which can still be developed in the future. For such, it is provided a calibration function in the system for new types of luminous sources 2, which shall be accessed before the use of the new luminous source 2.

In general, when it is necessary to use a luminous source 2 not provided by the system's initial project, the user just needs to previously select a function of adaptation/calibration of the optical sensor 7, so that he can include, at least, a specification data of the luminous source 2 provided by the manufacturer and, in addition, proceed with the capture of light in at least two different conditions of luminous intensity.

More specifically, to make such adaptation/calibration possible, the optical sensor 7 shall have a substantially linear behavior, that is, the variation of the output voltage (or current) of the optical sensor 7 shall vary proportionally in relation to the variation of incident light. Calibration occurs through the capture of light by the optical sensor 7 in at least two known conditions of power emitted by the luminous source 2, such as null power (luminous source 2 turned out/turned off) and maximum power (luminous source 2 adjusted to its maximum output). Naturally, the manufacturer of the luminous source 2 shall provide the value of this maximum power, or another intermediary value of power, as long as it corresponds to an adjustable condition in the luminous source 2 (for instance, by means of a key, knob or pontentiometer). The control unit 4 is configured to relate such value of maximum power, inserted by the user in the radiometer through the keys, to the value of voltage (or current) of the optical sensor 7 in the condition of maximum power, in order to allow the achievement of the maximum irradiance value. Therefore, based on these two irradiance values (null and maximum), it is possible to obtain the irradiance values under intermediary conditions of power by means of arithmetic interpolation.

Thus, the adaptation/calibration of the optical sensor 7 to any type of luminous source 2, which exists or which has not been used yet, is performed without the need of updating the software or hardware of the radiometer, once the procedure for adjusting the sensor can be made by users themselves, sparing the services rendered by a qualified laboratory, which represents a great differential and a significant advantage compared to the systems currently known, apart from decreasing costs. For this reason, the system of the present invention does not require the previous calibration of the optical sensor 7 with several types of luminous sources 2, unlike the systems of the state of the art. One just needs to insert the correction factor calculated for this source and the device performs the mathematical calculations necessary to carry out the conversion of values.

The process of calibration described above only needs to be performed once before the use of the new luminous source 2; however, if the user desires, it is possible to repeat the process as many times as he wishes.

The system is capable of operating with a plurality of new luminous sources 2, being limited only by the storage capacity of its memory.

It is worth noting that the periodic calibration of the optical sensor 7 with at least one type of known luminous source 2 is still necessary, in order to ensure the reliability and suitability of the optical sensor 7 according to the rules in force; however, in the present invention, it is not necessary the calibration of the optical sensor 7 with all the types of luminous sources 2, differently from the systems which are currently known.

The system also comprises an interface unit 5, operatively associated with the control unit 4, configured to allow the communication between the system and an external device 6, for instance, a microcomputer such as a PC. The interface unit 5 may consist of an interface RS 232, USB, wireless (wi-fi, bluetooth, zigbee, etc), Firewire or any known means of communication. This type of communication allows the monitoring, assessment and analysis of data collected/calculated/measured by the system in order to facilitate the follow-up of the phototherapy treatment, the implementation of preventive/corrective maintenance and/or the verification of efficiency of the phototherapy equipment. For instance, to check efficiency in phototherapy equipments, it is recommendable to follow the Brazilian technical Standard NBR IEC 60601-2-50:2003, which requires in sub-article 50.104 thereof the measurement of total irradiance for bilirubin.

It is worth noting that the system described above can be applied to several types of devices and apparatuses, for instance, radiometers/photometers, tools for tests, diagnostic tools, medical-hospital equipment, etc.

### Method for Measuring Irradiance in Phototherapy

The present invention also refers to a method for measuring irradiance in phototherapy comprising the following steps:

i) selecting a type of luminous source 2 whose irradiance is wished to be measured;

ii) capturing the light emitted by the luminous source 2;

iii) converting the light captured in step ii into an electrical sign; and

iv) calculating at least one irradiance value from the type of luminous source 2 selected in step i and from the electrical sign emitted in step iii.

More specifically, step iv comprises the following sub-steps:

iva) calculating a correction factor according to the type of luminous source 2 selected, as explained above in the description of the system for measuring irradiance in phototherapy; and

ivb) multiplying the correction factor by a measured irradiance value.

Additionally, sub-step iva described above comprises the following sub-steps:
measuring luminous power; and
dividing the luminous power measured by a reference luminous power.

Preferably, step ii is preceded by a step of filtering luminous waves which have wavelengths shorter than 400 nm and longer than 550 nm.

Also preferably, step ii is preceded by a step of correcting the bending effect of the sun rays emitted by the luminous source over the optical sensor 7.

It is worth noting that the method described above can be applied to several types of devices and apparatuses, for instance, radiometers/photometers, tools for tests, diagnostic tools, medical-hospital equipments, etc.

### Radiometer

The radiometer or photometer per se consists of a device capable of measuring the amount of light or power emitted by area unit in a certain spectrum, that is, providing irradiance values in a certain range of the spectrum of light emitted by a known luminous source 2. Preferably, the radiometer of the present invention is used in phototherapy applications and, therefore, it is configured to measure irradiance in the visible blue spectrum (400 to 550 mm).

The radiometer has at least one optical sensor 7 already mentioned, capable of allowing the conversion of incident light into an electrical sign, as explained above in the description of the system for measuring irradiance in phototherapy.

Moreover, the radiometer also comprises at least one selection key capable of allowing the selection of a type of luminous source 2 whose irradiance is wished to be measured. More specifically, the selection key allows selecting among a fluorescent lamp, a halogen lamp, a conventional LED (for instance, gallium nitride), a Super-LED (for instance, a LED of gallium nitride and indium nitride), or any other means for luminous emission whose irradiance is wished to be measured, suitable for treating hyperbilirubinemia.

Additionally, the radiometer further comprises a control unit 4 (also already mentioned), operatively connected to the optical sensor 7 and to the selection key, configured to calculate at least one irradiance value from a data originated from the optical sensor 7 and from a command originated from the selection key.

The control unit 4 is configured to multiply at least one correction factor by the irradiance value initially calculated, according to the type of luminous source 2 selected through the key for selecting the type of luminous source 2. Such correction factor is the relation between the measured luminous power in relation to a reference luminous power, also as already explained in the description of the system for measuring irradiance in phototherapy.

Besides, the radiometer comprises at least one light diffuser 8, operatively associated with the optical sensor 7, capable of correcting the bending effect of the light rays emitted by the luminous source over the optical sensor 7.

The radiometer also comprises a light filter 9, arranged between the light diffuser 8 and the optical sensor 7, tuned in to allow capturing luminous waves which have wavelengths ranging from 400 to 550 nm, suitable for treating hyperbilirubinemia, or other possible ranges of interest.

Preferably, the radiometer also comprises at least one interface RS 232, operatively associated with the control unit 4, configured to allow the communication between the radiometer with an external computer for data exchange, in order to facilitate the monitoring of the phototherapy treatment and/or the performance of preventive/corrective maintenance.

The radiometer also comprises a screen capable of allowing the visualization of at least one irradiance value. Such screen may consist of, for instance, an alphanumeric display or a LCD screen.

Reiterating the foregoing, the control unit 4 of the radiometer is configured to allow the adaptation/calibration of the optical sensor 7 to any type of luminous source 2, even the sources which have not been used yet for such purpose. For such, it is foreseen a function of calibration of the radiometer for new types of luminous sources 2, which shall be accessed before using the new luminous source 2, and such function can be accessed by the user through selection keys and through the alphanumeric display or LCD screen.

When it is necessary to use a luminous source 2 not provided by the initial project of the radiometer, the user just needs to previously select a function of adaptation/calibration of the optical sensor 7 in the radiometer, so that he can include at least one specification data of the luminous source 2 provided by the manufacturer and, besides, proceed with the capture of light in at least two different conditions of luminous intensity.

More specifically, to make such adaptation/calibration possible, the optical sensor 7 shall have a substantially linear behavior, that is, the variation of the output voltage (or current) of the optical sensor 7 shall vary proportionally in relation to the variation of incident light. Calibration occurs through the capture of light by the optical sensor 7 in at least two known conditions of power emitted by the luminous source 2, such as null power (luminous source 2 turned out/turned off) and maximum power (luminous source 2 adjusted to its maximum output). Naturally, the manufacturer of the luminous source 2 shall provide the value of this maximum power, or another intermediary value of power, as long as it corresponds to an adjustable condition in the luminous source 2 (for instance, by means of a key, knob or pontentiometer). The control unit 4 is configured to relate such value of maximum power, inserted by the user in the radiometer through the keys, to the value of voltage (or current) of the optical sensor 7 in this condition of maximum power, in order to allow the achievement of the maximum irradiance value. Therefore, based on these two irradiance values (null and maximum), it is possible to obtain the irradiance values under intermediary conditions of power by means of arithmetic interpolation.

Thus, the adaptation/calibration of the optical sensor 7 to any types of luminous source 2, even those which have not been developed yet, is performed without the need of updating the software or hardware of the radiometer, once the procedure for adjusting the sensor can be made by users themselves, sparing the services rendered by a qualified laboratory, which represents a great differential and a significant advantage compared to the radiometers currently known, apart from decreasing costs. For this reason, the system of the present invention does not require the previous calibration of the optical sensor 7 with several types of luminous sources 2, unlike the systems from the state of the art. One just needs to insert the correction factor calculated for this source and the device performs the mathematical calculations necessary to carry out the conversion of values.

Therefore, the radiometer of the present invention allows reading the intensity of irradiance for each type of lamp and, for this, it is just necessary to choose, in the menu of options, the desired lamp (fluorescent, halogen, LEDs, or any other type of suitable luminous source, and only in the last case, it may be necessary calibration). In other words, by analyzing the luminous emission spectrum of each type of lamp, it was developed a device capable of measuring and presenting a real value of the luminous irradiance through the selection of the type of lamp (one just needs to insert the correction factor calculated for this source and the device performs the mathematical calculations necessary to carry out the conversion of values).

The radiometers actually known, in their turn, are not capable of correcting the value of measure for different types of light sources.

Furthermore, the radiometer allows the storage of data obtained from several phototherapies in one neonatal ITU (intensive treatment unit) so that it can be sent to a computer for the analysis of the values administered in each patient, apart from enabling the verification of the efficiency of light for a possible exchange or preventive maintenance.

Moreover, the radiometer may also be used to acquire data from other equipments, for instance, incubator, warm cradle, etc.

Besides, in order to keep a traceable standard of the optical sensor 7, it was introduced, in the body of its cable, a manual adjustable device which allows the correction of a possible deviation arising from the variation of each sensor. This way, all sensors can be adjusted according to a standard of traceable measure by a qualified optics laboratory.

It is worth noting that the preferable irradiance unit shown by the radiometer is uW/cm².nm (microwatts per square centimeter by nanometer).

### Multiuse Measurement Tool

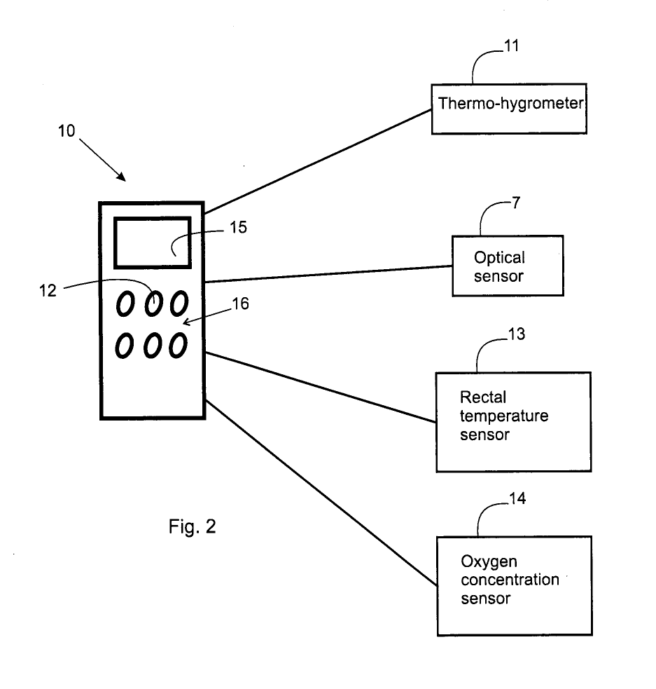

The present invention further refers to a multiuse measurement tool 10, illustrated in FIG. 2, which consists of a portable device aimed at measuring air relative humidity, air temperature, skin temperature, rectal and dermal temperature, oxygen concentration and irradiance in the blue spectrum in phototherapies.

Such measurement device, developed for use in the medical-hospital field, comprises a box made of engineer plastic having a preferably micro-processed circuit capable of allowing the visualization of the measured values on an alphanumeric display 15. The multiuse measurement tool 10 also comprises a keyboard 16 for selecting the functions and individual sensors for the type of application.

In the hospital field, this tool helps healthcare professionals quickly measure several parameters necessary for the treatment of patients, whether adults, children or neonates.

In general, the tool has the following functions:
function “Thermo-Hygrometer”: indicates the environmental conditions (humidity) where the patient is accommodated, either an incubator or the environment air;
function “Skin temperature”: indicates the superficial temperature of the body or of a peripheral region from the patient;
function “Rectal temperature”: indicates the temperature of the patient's body measured in the rectum / dermis;
function “Dermal temperature”—indicates the dermis temperature
function “Oxygen”: indicates the concentration of oxygen inside the environment where the patient is found. This function may be employed in incubators for newborns, hyperbaric chambers, headpieces for oxygen therapy among others; and
function “Radiometer”: indicates irradiance in the visible blue spectrum employed in phototherapy for treating hyperbilirubinemia.

Therefore, in a preferable embodiment of the present invention, the multiuse measurement tool 10 has at least:
one first connector configured to allow the coupling of a thermohygrometer 11;
one second connector configured to allow the coupling of an optical sensor 7 capable of allowing the conversion of the incident light into an electrical sign (voltage or electric current);
one third connector configured to allow the coupling of a rectal or dermal temperature sensor 13;
one fourth connector configured to allow the coupling of a sensor for oxygen concentration 14;
one fifth connector configured to allow the coupling of a pressure sensor;
one selection key 12 capable of allowing the selection of a type of luminous source whose irradiance is wished to be measured; and
one control unit 4, already described, operatively connected to the optical sensor 7 and to the selection key 12, configured to calculate at least one irradiance value from a data originated from the optical sensor 7 and from a command originated from the selection key 12.

Naturally, other types of connectors and sensors can be implemented in the multiuse measurement tool 10 of the present invention, for instance, sensor of blood pressure, heartbeat, among others.

Measurements made by the multiuse measurement tool 10 can be sent to a computer with the patient's health records. Therefore, such health records can be fed with data on temperature, humidity, oxygen, oxygen saturation in the blood and irradiance.

Preferably, the multiuse measurement tool 10 comprises the same characteristics of the radiometer described above.

Finally, the characteristics of irradiance measurement and value correction in view of the type of emitting source can be part of any other hospital equipments, which continue to be part of the protection scope defined in the claims. For instance, the phototherapy equipment itself can have the means and devices discussed above to have the capacity of presenting correct irradiance values. Evidently, such equipment is also included in the protection scope of the claims, as well as any other hospital equipment with such capacity.

Essentially, the protection scope of the invention includes any hospital equipment, comprising:
at least one optical sensor 7 capable of allowing the conversion of the incident light into an electrical sign,
a selection key capable of allowing the selection of a type of luminous source 2 whose irradiance is wished to be measured; and
a control unit 4 operatively connected to the optical sensor 7 and to the selection key, the control unit 4 being configured to calculate at least one irradiance value from a data originated from the optical sensor 7 and from a command originated from the selection key.

In the equipment, the control unit 4 is configured to multiply at least one correction factor by the irradiance value initially calculated, according to the type of luminous source 2 selected through the selection key, wherein the correction factor lies in the relationship between an irradiance experimentally obtained in relation to a reference irradiance.

The selection key allows choosing from a fluorescent lamp, a LED, a Super-LED, a halogen lamp or any other source whose irradiance is wished to be measured.

The equipment further comprises at least:
a light diffuser 8 associated with the optical sensor 7, the light diffuser 8 being capable of correcting the bending effect of the light rays emitted by the luminous source over the optical sensor 7; and
a light filter 9 arranged between the light diffuser 8 and the optical sensor 7, the light filter 9 being tuned in to allow capturing luminous waves which have wavelengths ranging from 400 to 550 nm or other ranges of the spectrum of interest.
at least one interface RS 232 operatively associated with the control unit 4, the interface RS 232 being configured to allow the communication between the radiometer and an external computer.
a screen capable of allowing the visualization of at least one irradiance value.

The control unit 4 is configured to allow the calibration of the optical sensor 7 with any type of luminous source 2, as already previously explained in the description of the system and of the radiometer.

After describing examples of preferred embodiments, it shall be understood that the scope of the present invention encompasses other possible variations, being limited only by the contents of the attached claims, where the possible equivalents are included.

1-30. (canceled)

31. A radiometer comprising:
at least one optical sensor (7) configured to allow conversion of an incident light into an electrical sign;
at least one selection key configured to allow the selection of a type of luminous source (2) whose irradiance is wished to be measured; and
at least one control unit (4) operatively connected (i) to the at least one optical sensor (7) and (ii) to the at least one selection key,
wherein the at least one control unit (4) is:
at least one of a programmable microprocessor or a microcontroller;
configured to calculate at least one irradiance value from a data originated from the optical sensor (7) and from a command originated from the selection key; and
configured to apply a correction factor to the irradiance value based upon the type of luminous source (2).

32. The radiometer according to claim 31, wherein the correction factor lies in the relationship between an irradiance experimentally obtained in relation to a reference irradiance.

33. The radiometer according to claim 31, wherein the selection key allows selecting among at least one of a fluorescent lamp, a LED, a Super-LED, a halogen lamp, and any other source whose irradiance is wished to be measured.

34. The radiometer according to claim 31, further comprising:
one light diffuser (8) associated with the optical sensor (7), the light diffuser (8) being capable of correcting the bending effect of the light rays emitted by the luminous source over the optical sensor (7); and
one light filter (9) arranged between the light diffuser (8) and the optical sensor (7), the light filter (9) being tuned in to allow capturing luminous waves which have wavelengths ranging from 400 to 550 nm, specifically for assessment of the treatment of hyperbilirubinemia or another spectral range of interest.

35. The radiometer according to claim 31, further comprising at least one RS 232 interface operatively associated with the control unit (4), the interface RS 232 being configured to allow the communication between the radiometer with an external computer.

36. The radiometer according to claim 31, further comprising one screen capable of allowing the visualization of at least one irradiance value.

37. The radiometer according to claim 31, wherein the control unit (4) is configured to allow the calibration of the optical sensor (7) with any type of luminous source (2).

38. The radiometer according to claim 31, further comprising:
one first connector configured to allow coupling of a thermohygrometer (11);
one second connector configured to allow coupling of an optical sensor (7) capable of allowing the conversion of the incident light into an electrical sign;
one third connector configured to allow coupling of a rectal or dermal temperature sensor (13);
one fourth connector configured to allow coupling of an oxygen concentration sensor (14); and
one fifth connector configured to allow coupling of a pressure sensor.

39. The radiometer according to claim 31, wherein the radiometer is portable.
